(19) United States
(12) Patent Application Publication
(10) Pub. No.: US 2003/0145833 A1
(43) Pub. Date: Aug. 7, 2003

(54) Fuel injector with simplified assembly, Through an undivided valve cover

(76) Inventors: Werner Wagner, Gerlingen (DE); Siegfried Ruthardt, Altdorf (DE); Hermann Koch-Groeber, Stuttgart (DE); Andreas Gaudl, Remshalden (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/292,877

(22) Filed: Nov. 13, 2002

(30) Foreign Application Priority Data
Nov. 13, 2001 (DE) 1 01 55 609.8

(51) Int. Cl. F02M 1/00

(52) U.S. Cl. 123/470

(57) ABSTRACT

A device for fastening a fuel injector in the cylinder head of an internal combustion engine includes a fuel injector having the diameter d₀, a fastening screw screwed into the cylinder head, and a forklike clamping pad, penetrated by this fastening screw, with two tines of length l₂ and spacing d₂. The shaft of the fuel injector narrows in the direction of the injection nozzle to a diameter d₁, and the narrowed shaft is provided at one point with opposed extensions; the width l₁ at this point does not exceed the original diameter d₀ of the fuel injector.

### BACKGROUND OF THE INVENTION

1. Field of the Invention

In fuel injection systems for internal combustion engines, high-pressure injection systems with a common rail are increasingly being used. The fuel injectors of the engine are supplied by these high-pressure injection systems with fuel that is at very high pressure. Because of the prevailing pressure conditions, it is extremely important that the fuel injectors be secured firmly. Typically, the fuel injectors are mounted in the cylinder head with forked clamping pads (clamps).

2. Prior Art

In the fastening device for a fuel injector described in European Patent Disclosure EP-A 0 957 263, the tines of a clamping pad rest on flat recesses of the fuel injector. The tines furthermore have curved lugs that rest on shoulders of the fuel injector. The clamping pad is secured in the cylinder head by a fastening screw; it is additionally secured by a counterpart bearing, and a portion of the face of this counterpart bearing acts on the fulcrum of the clamping pad, the fulcrum being reinforced with a raised portion. If the injector is to be removed, among other things first the cover must be removed, along with the counterpart bearing. Accordingly this removal is labor-intensive and time-consuming.

The clamping pads of British Patent Disclosure GB-A 2 213 197 likewise have curved lugs that rest on shoulders of the fuel injector. The insides of their tines are flat and rest on flat recesses of the fuel injector. The part of the clamping pad opposed to the tines of the clamping pad is braced by an additional support arm. The fastening device for the fuel injector also includes a device that makes it possible to align the support arm.

German Patent DE-C 44 13 415 describes a fastening device in which the clamping pad is grasped in clawlike fashion by a clamp and is thus additionally secured. Once again, the tines of the clamping pad rest on flat recesses on the fuel injector.

The fastening devices for fuel injectors in the cylinder head of an internal combustion engine that are known from the prior art share the necessity of securing the clamping pad, by means of such additional devices as a counterpart bearing, support arm, or clamp, so that an optimal seat of the fuel injector can be assured. Moreover, the tines of the clamping pads each rest on flat recesses of the fuel injector.

Another common feature of the fastening devices known from the prior art is that upon assembly, the fuel injector must first be put in its final position, before the tines of the pad can be thrust from the side into the recesses on the injector. Finally, a screw or nut is typically installed, and the construction is fixed by means of screw force. For this type of assembly, there must be structural space available in the cylinder head, which in cylinder heads with four valves per cylinder is relatively hard to achieve. Moreover, the requirements for compactness of the cylinder head construction require that the lower part of the fuel injector be built into the oil fog chamber around the camshafts, so that on the shaft of the fuel injector, a seal that seals it off from the valve cover that closes off the oil fog chamber is provided.

### SUMMARY OF THE INVENTION

With the embodiment proposed according to the invention, in which the shaft of the fuel injector is narrowed in the direction of the injection nozzle from a diameter d₀ to a diameter d₁, and this narrowed shaft is provided with opposed extensions (that is, 180° from one another), where the width l₁ at the point with the extensions is no greater than the original diameter d₀, it is possible for the sake of assembly to push the shaft of the fuel injector through a bore in the valve cover that has the diameter d₀, and between the tines of the clamping pad that are spaced apart by d₂, far enough that the extensions are located below the tines of the clamping pad, and to secure it firmly by rotating it 90° and fastening the clamping pad with a fastening screw. In this case, d₁≦d₂. The fuel injector is now pressed firmly into its receiving bore in the cylinder head by the tines of the clamping pad that rest on the extensions. The force conditions here are the same as in the fastening devices known from the prior art. However, no additional fastening elements for securing the clamping pad are necessary—except for a fastening screw (tightening screw). It is equally unnecessary for the fuel injector to have flat recesses.

The removal of the fuel injector can be accomplished in a simple way, after the fastening screw has been loosened, by rotating it again by 90° and pulling the fuel injector out through the tines of the clamping pad and through the opening in the valve cover. It is no longer necessary to remove the valve cover. This is especially advantageous because removing the valve cover entails increased assembly effort and expense and runs the risk of soiling the oil fog chamber around the camshafts and their surrounding bearing during assembly.

Accordingly, once assembly of the valve cover has been done, the fuel injector can be installed from above through a round opening in the valve cover, so that the part of the fuel injector toward the injection nozzle is secured in the camshaft chamber with a pad located at a low point therein, while the part of the fuel injector having the high-pressure connection and the plug is located outside the camshaft chamber. Since the opening in the valve cover is round, sealing is very easily achieved. Thus it is unnecessary to use a divided valve cover.

A cylindrical sealing face is preferably provided on the shaft of the fuel injector, on which face the seal is seated in the valve cover. Since the force engagement by the pad preferably takes place close to the cylinder, the sealing face is attached to the fuel injector toward the top, above the pad.

The valve cover moreover has an additional opening, through which insertion of a tool for tightening or loosening the fastening screw of the clamping pad is made possible. The dimension of this opening is determined by the dimension of the tool for loosening and tightening the fastening screw. The opening can be closed with a simple stopper or a screw.

It is accordingly possible first to install the clamping pad, then the valve cover, and finally the fuel injector, and to secure the fuel injector firmly by tightening the fastening screw that penetrates the clamping pad.

The extensions on the shaft of the fuel injector can be shaped arbitrarily and have a variable material thickness, but the following conditions should be adhered to: The width l₁ of the fuel injector at the point provided with extensions is less than or equal to the original diameter d₀ of the fuel injector. Preferably, the width l₁ is less than or equal to the length of the tines of the clamping pads l₂ (l₁≦l₂). Moreover, the extensions are preferably so large that in the installed state, the tines with the width d₃ rest completely on the extensions; that is, l₁=d₁+d₃. The tines of the clamping pad are embodied as generally rectangular. Preferably, their corners are rounded. In the installed state, the tines usually do not rest directly on the shaft of the fuel injector but instead have a spacing from it of tenths of a millimeter.

The narrowed shaft of the fuel injector has a diameter d₁, which is less than the spacing d₂ of the two tines of the clamping pad from one another. The spacing d₅ of the extensions from the point on the fuel injector where the fuel injector still has the diameter d₀ must be at least as great as the material thickness d₄ of the tines of the clamping pad.

In general, the extensions are of the same material as the shaft of the fuel injector and are integral with the shaft. However, it is also possible for the extensions to be formed initially as separate parts, and joined to the fuel injector shaft.

### BRIEF DESCRIPTION OF THE DRAWINGS

The invention is described in further detail below in conjunction with the drawings, in which:

FIG. 1 is a section through part of a cylinder head of an internal combustion engine, with a conventionally installed fuel injector and a separate valve cover;

FIG. 2 is a front perspective view of an embodiment of a fastening device according to the invention;

FIGS. 3a and 3b are each variant embodiment of a fastening device of the invention, in plan view;

FIG. 4 is a section through part of a cylinder head of an internal combustion engine, with a fuel injector installed according to the invention and with an undivided valve cover, in a front view; and

FIG. 4a is an enlargement of the detail marked Z in FIG. 4.

### DESCRIPTION OF THE PREFERRED EMBODIMENTS

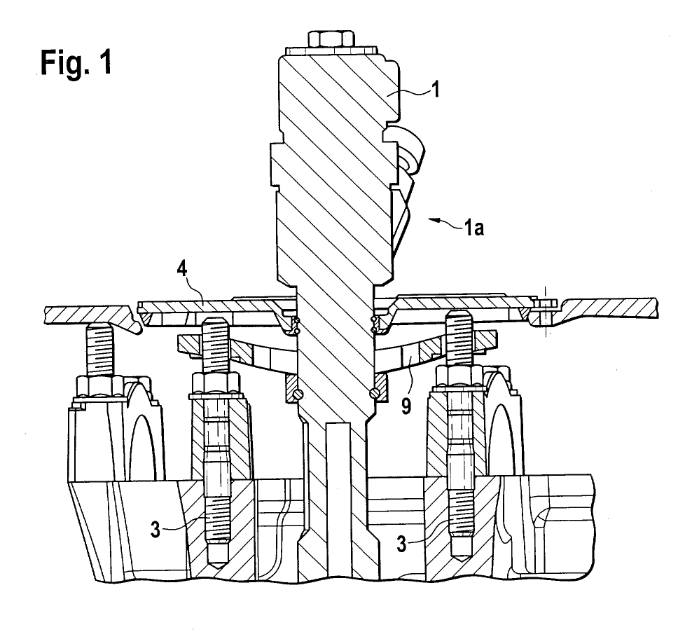

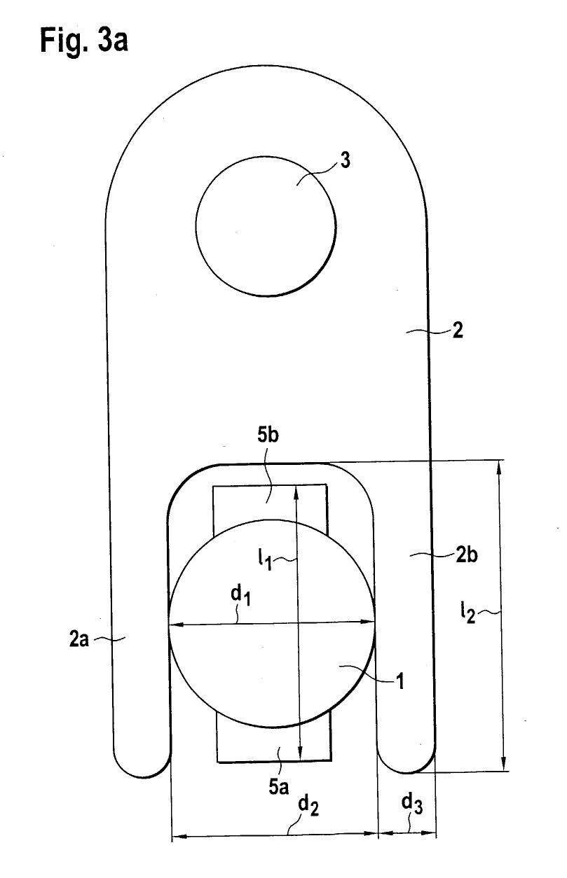

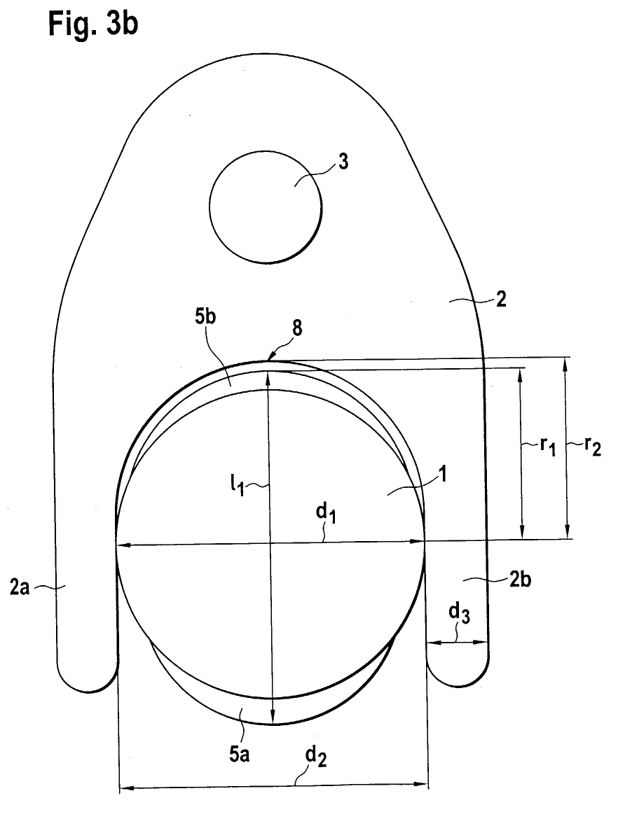

In the drawings, FIGS. 1, 2, 4 and 4a show the fuel injector in the installed state, while FIGS. 3a and 3b show it in the uninstalled state. FIG. 1 shows a device, known from the prior art, for fastening a fuel injector 1. The part la of the fuel injector having the connection stub for the common rail is located outside the camshaft chamber of the internal combustion engine. The part of the fuel injector toward the injection nozzle is located in the camshaft chamber, where it is secured via a crosspiece 9 that is secured to the cylinder head with two fastening screws 3. If the fuel injector has to be removed, the valve cover 4 must also be removed.

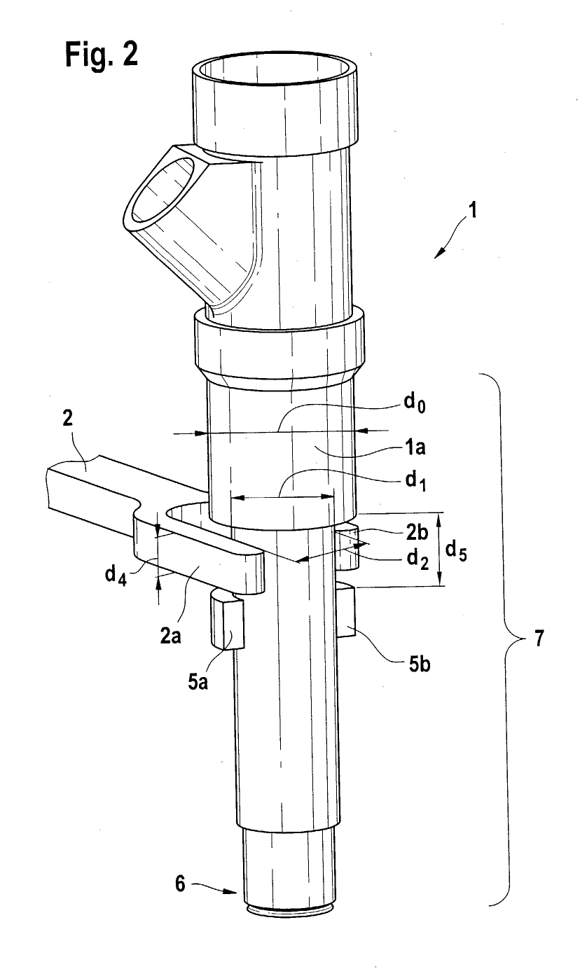

FIG. 2 shows a device according to the invention for fastening a fuel injector 1 in the cylinder head of the camshaft chamber of an internal combustion engine, with the fuel injector 1 having a shaft 7 which narrows, toward the injection nozzle 6, from a diameter d₀ to a diameter d₁, and on whose narrowed shaft there are opposed extensions 5a and 5b at a spacing d₅ from the injector part 1a that has the diameter d₀. In the installed state of the fuel injector as shown here, the tines 2a and 2b of the forklike clamping pad 2, which have a material thickness d₄, rest on the extensions. The extensions 5a and 5b are embodied here as rectangular on the side facing away from the fuel injector. It can be seen clearly that the portion of the clamping pad (5) having the extensions 5a and 5b is no wider than the original diameter d₀ of the fuel injector. The spacing d₅ must be at least as great as the material thickness d₄ of the tines 2a and 2b.

In FIG. 3a, the fastening device of the invention, shown in FIG. 2, can be seen in plan view and in the uninstalled state. The clamping pad 2 in this drawing is shown complete, as is its fastening screw 3. At the point that is provided with extensions 5a and 5b, the fuel injector 1 has a diameter d₁, which at maximum is as great as the spacing d₂ of the two tines 2a and 2b of the clamping pad from one another. The point with the extensions 5a and 5b has a width l₁, which at maximum is as great as the original diameter d₀ of the fuel injector. Preferably, the width l₁ is less than or equal to the length of the tines l₂. Furthermore, the extensions 5a and 5b are preferably each as wide as the width d₃ of the tines 2a and 2b, so that the equation d₁+2d₃=l₁ is true.

FIG. 3b shows a further fastening device of the invention for securing a fuel injector 1 with a clamping pad 2 that has two tines 2a and 2b and is fastened to the cylinder head via a fastening screw 3. This illustration shows the fastening device in plan view and shows the fuel injector in the uninstalled state. The extensions 5a and 5b here are adapted to the dimensions of the clamping pad at its lowest point 8. The shaft of the fuel injector, at the point with the extensions, has a diameter d₁. Here, r₁≦r₂, and r₁=l₁/2, and r₂ is the length of the tines 2a and 2b from the lowest point 8 of the clamping pad to the center of the narrowed fuel injector shaft having the diameter d₁. As in the variant embodiment of FIG. 3a, it is true that d₁≦the spacing d₂ of the two tines 2a and 2b from one another, and l₁≦the original diameter d₀ of the fuel injector, and preferably, l₁=d₁+d₃, and d₃=the width of the tines 2a and 2b.

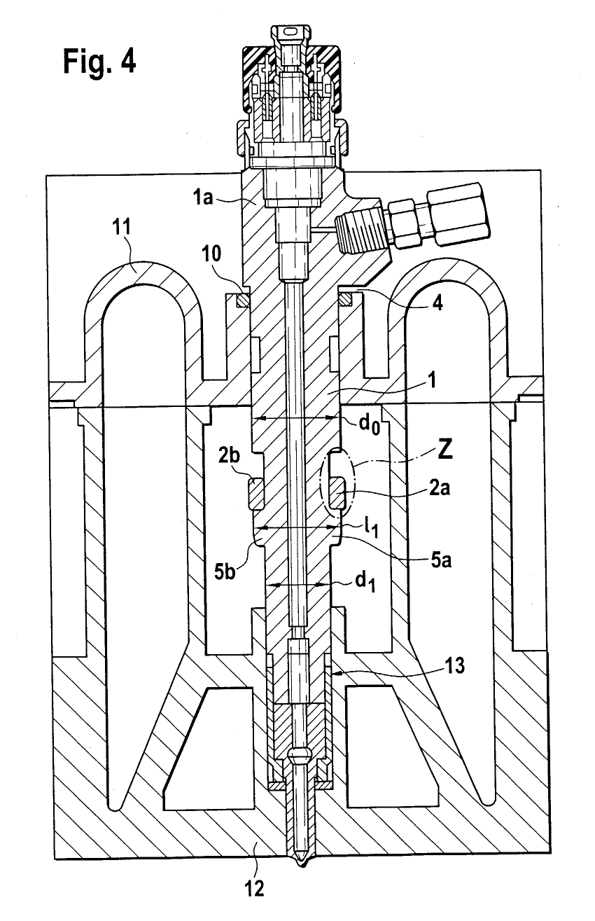

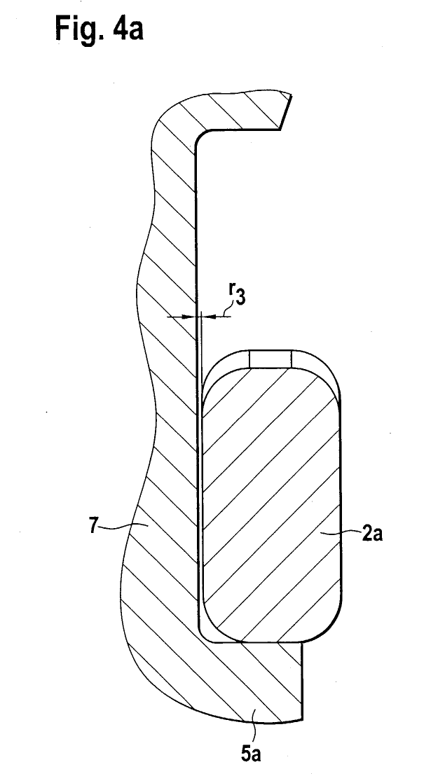

FIG. 4 shows a fuel injector 1 which is secured by a fastening device according to the invention. The fuel injector 1 rests on the undivided valve cover 4 by way of a cylindrical sealing face 10. Here 11 indicates the internal combustion engine. The part 1a of the fuel injector having the connection stub for the common rail is located outside the camshaft chamber. The lower part of the fuel injector, in the installed state shown, is pressed into the receiving bore 13 in the cylinder head 12. The fastening screw for the clamping pad is fastened (not shown) in the cylinder head 12. Upon disassembly of the fuel injector, after the fastening screw of the clamping pad is loosened and the fuel injector has been rotated 90°, the fuel injector can simply be pulled through the valve cover 4.

In FIG. 4a, a detail of a fastening device of the invention is shown in the installed state. One tine 2a of the clamping pad rests on one of the extensions 5a attached to the shaft 7 of the fuel injector. The tine 2a of the clamping pad is embodied in rounded fashion and has a slight spacing r₃ from the shaft of the fuel injector. The spacing r₃ is in the range of tenths of a millimeter.

The foregoing relates to preferred exemplary embodiments of the invention, it being understood that other variants and embodiments thereof are possible within the spirit and scope of the invention, the latter being defined by the appended claims.

We claim

1. A device for fastening a fuel injector (1) in the cylinder head (12) of an internal combustion engine, the fuel injector (1) having a diameter d₀, the device
a fastening screw (3) screwed into the cylinder head (12),
a forklike clamping pad (2) penetrated by the fastening screw, (3)
the clamping pad (2) having two tines (2a, 2b) of length l₂ and spacing d₂,
a reduced diameter d₁ on the shaft (7) of the fuel injector (1) in the direction of the injection nozzle (6)
opposed extensions (5a, 5b) provided on the narrowed shaft at one point, and
the width l₁ at the point of the opposed extensions does not exceed the original diameter d₀ of the fuel injector.

2. The device of claim 1, wherein the clamping pad, on its free end, is braced on a support face on the cylinder head, and in the installed state of the fuel injector, on its other free, forklike end, rests on the opposed extensions (5a, 5b) and presses the fuel injector into a receiving bore (13) of the cylinder head (12).

3. The device of claim 1, wherein the extensions (5a, 5b) are embodied as rectangular on the side remote from the fuel injector (1).

4. The device of claim 2, wherein the extensions (5a, 5b) are embodied as rectangular on the side remote from the fuel injector (1).

5. The device of claim 1, wherein the extensions (5a, 5b), on the side remote from the fuel injector (1), are adapted to the dimensions of the clamping pad at its lowest point (8), and optionally r₁, which is half the width l₁, is less than or equal to the length r₂ of the tines 2a and 2b from the lowest point 8 of the clamping pad as far as the center of the narrowed fuel injector shaft having the diameter d₁.

6. The device of claim 2, wherein the extensions (5a, 5b), on the side remote from the fuel injector (1), are adapted to the dimensions of the clamping pad at its lowest point (8), and optionally r₁, which is half the width l₁, is less than or equal to the length r₂ of the tines 2a and 2b from the lowest point 8 of the clamping pad as far as the center of the narrowed fuel injector shaft having the diameter d₁.

7. The device of claim 1, wherein the point having the extensions (5a, 5b) is located at a spacing d₅ from the part (1a) of the fuel injector having the diameter d₀, and the tines (2a, 2b) of the clamping pad have a material thickness d₄.

8. The device of claim 7, wherein the spacing d₅ is greater than or equal to the material thickness d₄ of the tines of the clamping pad.

9. The device of claim 2, wherein the spacing d₅ is greater than or equal to the material thickness d₄ of the tines of the clamping pad.

10. The device of claim 3, wherein the spacing d₅ is greater than or equal to the material thickness d₄ of the tines of the clamping pad.

11. The device of claim 5, wherein the spacing d₅ is greater than or equal to the material thickness d₄ of the tines of the clamping pad.

12. The device of claim 1, wherein the extensions (5a, 5b) are as wide as the tines (2a, 2b).

13. The device of claim 2, wherein the extensions (5a, 5b) are as wide as the tines (2a, 2b).

14. The device of claim 3, wherein the extensions (5a, 5b) are as wide as the tines (2a, 2b).

15. The device of claim 8, wherein the extensions (5a, 5b) are as wide as the tines (2a, 2b).

16. The device of claim 1, wherein the length l₂ of the tines (2a, 2b) is greater than or equal to the width l₁ at the point having the extensions (5a, 5b).

17. The device of claim 5, wherein the length l₂ of the tines (2a, 2b) is greater than or equal to the width l₁ at the point having the extensions (5a, 5b).

18. The device of claim 8, wherein the length l₂ of the tines (2a, 2b) is greater than or equal to the width l₁ at the point having the extensions (5a, 5b).

19. The device of claim 12, wherein the length l₂ of the tines (2a, 2b) is greater than or equal to the width l₁ at the point having the extensions (5a, 5b).

20. The device of claim 1, further comprising a cylindrical sealing face (10) attached to the shaft of the fuel injector above the clamping pad (2).
